(19) United States
(12) Patent Application Publication
(10) Pub. No.: US 2003/0085917 A1
(43) Pub. Date: May 8, 2003

(54) Method of providing user interface via web

(76) Inventors: Woo-Seok Chang, Kuri (KR); Tai-Dong Ha, Seoul (KR); Young-Mi Kang, Seoul (KR); Dong-Won Lee, Saratoga, CA (US)

Correspondence Address: Douglas G. Hodder, Morrison & Foerster LLP, 755 Page Mill Road, Palo Alto, CA, 94304-1018, US

(21) Appl. No.: 10/150,205

(22) Filed: May 17, 2002

(30) Foreign Application Priority Data
Jul. 10, 2001 (KR) 2001-41052

(51) Int. Cl. G09G 5/00

(52) U.S. Cl. 345/738

(57) ABSTRACT

Disclosed is a method of providing a user with diverse UIs by downloading a UI of an application program from a web server in a web page format, and displaying the diversified UIs on a client's PC. The method according to the invention includes the steps of executing, by a user, the application program installed at the client's PC to request the web server to transmit a UI web page stored therein via the web browser module; transmitting, by the web server, the requested UI web page to the web browser module; and executing and displaying the transmitted UI web page, by the web browser module.

### RELATED APPLICATIONS

The present application claims priority to Korean Application No. 200141052, filed Jul. 10, 2001, entitled “Method of providing user interface via web” by Woo Seok Chang, Tai Dong Ha, Young Mi Kang and Dong Won Lee and incorporates that application by reference.

### BACKGROUND OF THE INVENTION

1. Field of the Invention

The present invention relates to a method of providing a user interface (UI) via web, and in particular, to a method of providing a user with diverse UIs by downloading a UI of an application program from a web server in a web page format, and displaying the U's on a client's PC.

2. Description of the Related Art

The UI refers to a part of a computer that exchanges information with a human. In principle, the UI was meant to include input devices such as a keyboard and output devices such as a display. Nowadays, however, the UI generally means a screen status displaying operations of a computer on a screen. Recently, most of the computers adopt a graphic user interface (GUI) providing a graphic screen.

In general, UI of the computer program is provided by their respective operating systems (OS). Also, UIs of application programs are produced by using an application program interface (API) provided by the OS.

Thus, the application programs have been conventionally developed by using the basic UI provided by the OS such as Windows or UNIX. As a consequence, the users can use UIs of fixed frame only, having no chance of enjoying the UIs which has a variety of designs. The users also need to consume a considerable amount of effort and time to modify the basically provided UI.

### SUMMARY OF THE INVENTION

Therefore, it is an object of the present invention to provide a method of providing a user-friendly UI via web, which downloads a UI of the application program, in a web page format, from a web server, and executing and displaying the downloaded UI on a client's PC, thereby the user being able to be connected with a web server at any time while the user is using the UI of an application program and the user enjoying a variety of UI designs.

It is another object of the present invention to provide a method of push-servicing information useful to a client while transmitting a UI web page from a web server to the client.

The method of providing a UI via web according to the present invention is performed in a system, which comprises a client's PC having an application program and a web browser module, and a web server storing a UI web page to replace a UI of the application program. The method of providing a UI via web according to the present invention comprises the steps of: (a) executing, by a user, an application program installed at the client's PC to request a web server to transmit a UI web page stored therein via a web browser module of the client's PC; (b) transmitting, by the web server, the requested UI web page to the web browser module; and (c) executing and displaying the transmitted UI, by the web browser module of the client's PC.

The method according to the present invention may further comprise a step of constructing a web page by reading information of the user from the client's database by means of a script housed in the web page transmitted from the web server, so as to set up personal information of the user on the UI web page.

Here, the UI concerning a particular menu of the application program installed at the client's PC may be stored in the web server in diverse web page formats, and the user may set up a UI web page to be used by the user in the web server in advance. On the other hand, in taking the step (a) above, a button for calling the UI web page of the web server may be included in the application program so that the user can select the button to enable the web browser module to call the UI web page of the web server.

Meanwhile, the method according to the present invention is applicable to an information push-service by adding the steps of: installing a listener, which is a module for receiving information, when installing the application program in the client's PC; transmitting, by the web browser module, an IP address of the client's PC when requesting the web server to transmit the UI web page; and storing in the web server the IP address of the client's PC and transmitting information to the listener of the client's PC. Here, the information push-service, which has recently appeared terminology, means an automated service that allows subscribers to receive information via web or e-mail.

### BRIEF DESCRIPTION OF THE DRAWINGS

The above and other objects, features and advantages of the present invention will become more apparent from the following detailed description when taken in conjunction with the accompanying drawings, in which:

FIG. 1 is a signal flowchart illustrating a method of providing a UI web page according to the present invention; and

FIG. 2 is a signal flowchart illustrating a method of providing a UI web page according to an application example of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

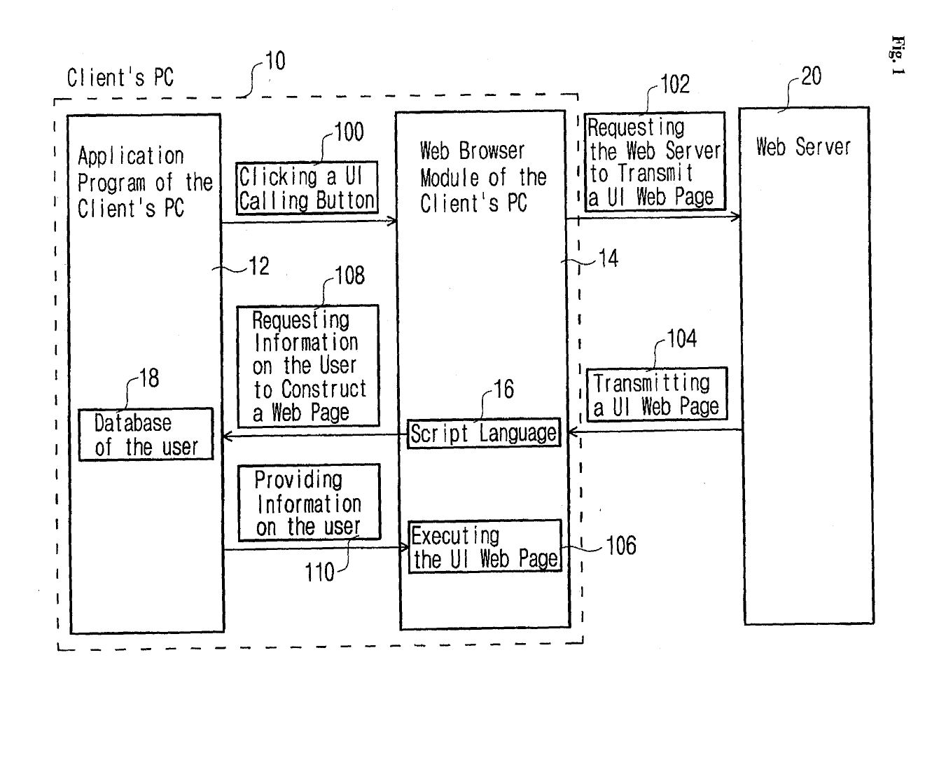

FIG. 1 is a signal flowchart illustrating a method of providing a UI web page according to the present invention. Referring to FIG. 1, a client's PC 10 includes an application program 12 and a web browser module 14. The web browser module 14 is a module functioning as ordinary web browsers (Internet Explorer, Netscape Navigator, etc.) to access a web server 20 of a program provider via web and display an HTML document.

The web server 20 stores a main screen of the application program itself or a UI corresponding to a particular menu in a web page format. If the client's PC selects the button for calling the corresponding UI web page (hereinafter, also referred to as a “web UI”) while using the application program, the requesting signal is transmitted to the web server 20, and the corresponding web UI is transmitted to the web browser module 14 of the client's PC via web. Thus, the user may use, as a UI of an application program, the UI provided by the web server, while being connected to the web server in real time.

The web server 20 may store a variety of UI web pages so as to be arbitrarily selected and used by the user. For instance, the web server 20 may store diversely modified UIs of a particular application program, in web page formats. Purchasing the application program, the user may select and set up the web UI to be used by himself/herself in the web server 20. If the user clicks a button related to the web UI while using the application program after installing the application program at his/her own PC (the client's PC), the corresponding web UI is downloaded, executed, and displayed on the web browser module of the client's PC via web. Accordingly, the present invention can be carried out under a basic assumption that the client's PC 10 is always connected to the web server 20 via Internet.

According to the present invention, the main UI of the application program itself may be stored in the web server 20 as a web page. Or, UIs of only partial menus or functions of the application program may be stored in the web server 20 in diverse formats.

Meanwhile, depending on the applicability, a button for calling the web UI according to the present invention may be installed on the application programs already in market. If the user clicks this button while using the application program, the web UI stored at the web server 20 in advance is displayed by the web browser 14 of the client's PC via Internet. Then, the user may use this web UI as a UI of the application program.

At present, the technology of setting up a separate button in an application program for enabling the user to arbitrarily control the button is well known. Examples are the “browser helper object”, which is a program provided for Internet Explorer of Microsoft Corporation, and the “plug-in” program provided for some application programs. The present invention is to realize calling U's from outside by using such technology.

Operation of the present invention will now be described with reference to FIG. 1. As a basic assumption, the user installs the application program 12 at his/her own client PC 10, and executes the application program 12 under the state of being connected to the web server 20 via Internet.

The user executes the application program 12, and selects (clicks) a web UI calling button installed in the application program 12 or a particular menu thereof [100]. Then, the web browser module 14 of the client's PC 10 transmits a signal for requesting the web server 20 to transmit the corresponding UI web page [102]. The web server 20 provides the requested UI web page to the web browser module 14 [104], which, in return, executes and displays the transmitted UI web page [106].

Meanwhile, if it is necessary to set up personal information of the user on the UI web page, the web browser module 14 may request the client's user database 18 to transmit the information on the user via a script 16 housed in the UI web page, which has been transmitted from the web server 20 [108]. Based on the information, if received [110], the web browser module 14 may construct and execute a UI web page [106].

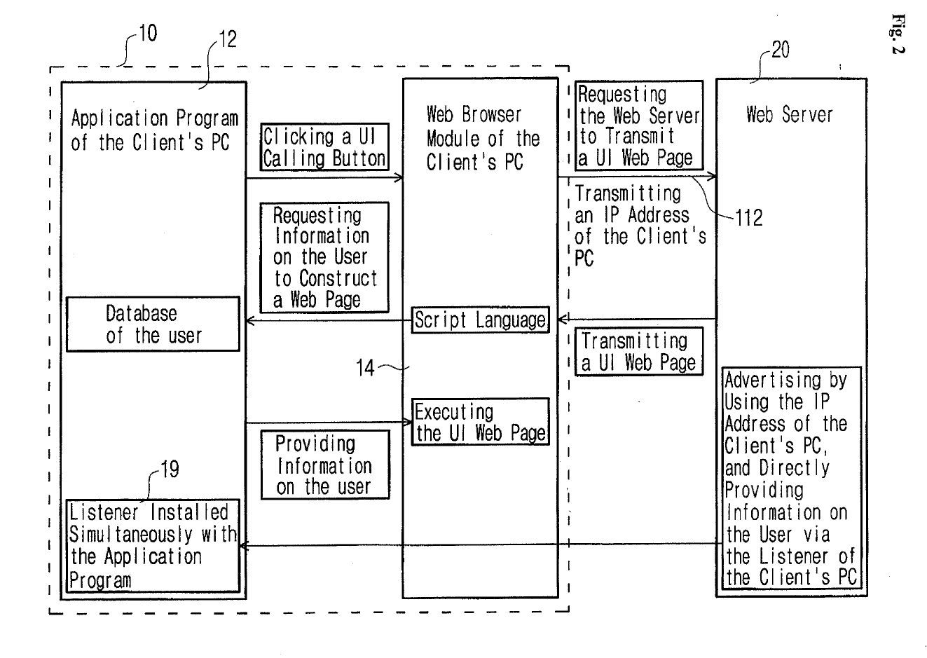

FIG. 2 illustrates an application example of the present invention in FIG. 1. The example pertains to a model of providing the client's PC 10 with an information push-service from the web server 20 by using the method of providing a web UI according to the present invention.

Flowchart in FIG. 2 is similar to that in FIG. 1 as a whole. The difference lies in that a listener 19 for performing the information push-service according to the present invention is also installed simultaneously with the application program 12 at the client's PC 10. The listener 19 is a module for receiving information. Another difference lies in that the IP address of the client's PC 10 is transmitted to the web server 20 when the web browser module 14 requests the web server 20 to transmit a UI web page [112]. Then, the web server 20 stores the IP address of the client's PC 10, and transmits advertisements or information useful to the user directly to the client's information receiving module 19. The client's PC 10 then receives the information transmitted from the web server 20 so as to be provided with the push-service.

Thus, the web server according to an embodiment of the present invention also functions as an application service provider (ASP) in addition to the function of providing a web UI.

The method of providing a UI via web according to the present invention provides various user-friendly Uis. Further, the user, who is accessed to a designated web site whenever executing an application program, can be easily benefited with a variety of information provided by the application program provider together with the information necessary for upgrading the product via a web UI. Meanwhile, if a contents provider has provided a web UI only, he/she is able to inclusively manage the UI and transmit information on additional services to individual users, thereby creating a new business model.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of providing a user interface (UI) via a network in a system including a client PC having an application program and a network browser module, and a network server for storing a UI network page to replace a UI of the application program, the method comprising:
(a) executing, by a user, the application program installed at the client PC to request the network server to transmit the UI network page stored in the network server via the network browser module;
(b) transmitting, by the network server, the requested UI network page to the network browser module; and
(c) executing and displaying, by the network browser module, the transmitted UI web page.

2. The method of claim 1, further comprising reading user information from a database on the client PC by using a script housed in the UI network page, which has been transmitted from the web server, and constructing a modified UI network page to include the user information.

3. The method of claim 1, further comprising:
installing a listener when installing the application program in the client PC;
transmitting an IP address of the client PC when requesting the network server to transmit the UI network page by the network browser module; and
storing the IP address of the client PC and transmitting information to the listener of the client PC by the web server.

4. The method of claim 1, wherein a UI concerning a particular menu of the application program installed at the client PC is stored in the network server in diverse network page formats, and the user sets up a UI network page to be used by the user in the network server in advance.

5. The method of claim 2 wherein a UI concerning a particular menu of the application program installed in the client PC is stored in the web server in diverse web page formats, and the user sets up in advance in the server a UI network page to be used by the user.

6. The method of claim 3 wherein a UI concerning a particular menu of the application program installed in the client PC is stored in the network server in diverse web page formats, and the user sets up in advance in the network server a UI network page to be used by the user.

7. The method of claim 1 wherein step (a) includes providing in the application program a button for calling the UI network page of the network server in the application program so that the user can select the button to enable the network browser module to call the UI network page of the network server.

8. The method of claim 2, wherein step (a) includes providing in the application program a button for calling the UI network page of the network server so that the user can select the button to enable the network browser module to call the UI network page of the network server.

9. The method of claim 3, wherein step (a) includes providing in the application program a button for calling the UI network page of the network server so that the user can select the button to enable the network browser module to call the UI network page of the network server.
